(19) United States
(12) Patent Application Publication
(10) Pub. No.: US 2015/0342834 A1
(43) Pub. Date: Dec. 3, 2015

(54) GASTROSTOMY DEVICE WITH CONTROLLED SHAPE SILICONE BALLOON

(71) Applicant: Boston Scientific Scimed, Inc., Maple Grove, MN (US)

(72) Inventors: Gerald Fredrickson, Westford, MA (US); Stan R. Gilbert, Litchfield, NH (US)

(21) Appl. No.: 14/725,896

(22) Filed: May 29, 2015

Related U.S. Application Data
(60) Provisional application No. 62/005,378, filed on May 30, 2014.

(51) Int. Cl. A61J 15/00

(52) U.S. Cl. CPC A61J 15/0015

(57) ABSTRACT

A gastrostomy device includes an elongate tube extending from a proximal end to a distal end and having a tube diameter. The elongate tube has a length that enables the elongate tube to extend from a position exterior a patient to a position interior the patient's stomach. A resealable valve is disposed within the proximal end of the elongate tube. An inflation lumen extends along the elongate tube and an inflation port is disposed near the proximal end of the elongate tube and is in fluid communication with the inflation lumen. A silicone balloon is secured relative to the distal end of the elongate tube and is in fluid communication with the inflation lumen. The silicone balloon has a distal region, a proximal region and an intervening middle region that, when inflated, stretches more than the distal region or the proximal region.

### CROSS-REFERENCE TO RELATED APPLICATIONS

This application claims priority under 35 U.S.C. §119(e) to U.S. Provisional Application No. 62/005,378, filed May 30, 2014, the entire disclosure of which is herein incorporated by reference.

### TECHNICAL FIELD

The present disclosure pertains to medical devices. More particularly, the present disclosure pertains to medical devices such as gastrostomy devices.

### BACKGROUND

A wide variety of intracorporeal medical devices have been developed for medical use. Some of these devices include gastrostomy devices. These devices are manufactured by any one of a variety of different manufacturing methods and may be used according to any one of a variety of methods.

### SUMMARY

This disclosure provides design, material, manufacturing method, and use alternatives for medical devices. An example medical device is a gastrostomy device that includes an elongate tube extending from a proximal end to a distal end and having a tube diameter. The elongate tube has a length that enables the elongate tube to extend from a position exterior a patient to a position interior the patient's stomach. A resealable valve is disposed within the proximal end of the elongate tube. An inflation lumen extends along the elongate tube and an inflation port is disposed near the proximal end of the elongate tube and in fluid communication with the inflation lumen. A silicone balloon is secured relative to the distal end of the elongate tube and is in fluid communication with the inflation lumen. The silicone balloon has a distal region, a proximal region and an intervening middle region that, when inflated, stretches more than the distal region or the proximal region.

Another example medical device is a gastrostomy device that includes an elongate tube extending from a proximal end to a distal end, an inflation lumen extending along the elongate tube and a silicone balloon secured relative to the distal end of the elongate tube and in fluid communication with the inflation lumen, the silicone balloon having a distal region, a proximal region and an intervening middle region. The middle region has a reduced wall thickness relative to a distal region wall thickness or a proximal region wall thickness such that when inflated the middle region of the silicone balloon will preferentially expand more than the distal region or the proximal region.

Another example medical device is a gastrostomy device that includes an elongate tube extending from a proximal end to a distal end, an inflation lumen extending along the elongate tube and a silicone balloon that is secured relative to the distal end of the elongate tube and in fluid communication with the inflation lumen. The silicone balloon has a distal region, a proximal region and an intervening middle region that includes a lower modulus silicone relative to silicone in a distal region or a proximal region such that when inflated the middle region of the silicone balloon will preferentially expand more than the distal region or the proximal region.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a side view of a gastrostomy device including a silicone balloon;

FIG. 2 is a cross-sectional view of the gastrostomy device of FIG. 1, illustrating the silicone balloon in a deflated configuration;

FIG. 3 is a cross-sectional view of the gastrostomy device of FIG. 1, illustrating the silicone balloon in an inflated configuration;

FIG. 4 is a schematic view of the gastrostomy device of FIG. 1, shown in position within a patient's abdomen;

FIG. 5 is a schematic view of a silicone balloon useful as part of the gastrostomy device of FIG. 1; and

FIG. 6 is a schematic view of a silicone balloon useful as part of the gastrostomy device of FIG. 1.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the disclosure.

### DETAILED DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

A variety of medical conditions can render a patient unable to eat on their own. In such situations, a patient may be fed using a feeding tube. In doing so, a device known as a gastrostomy device may be implanted in the patient. A gastrostomy device generally extends from a position exterior the patient to a position interior the patient's stomach. The gastrostomy device may be configured to accommodate a feeding tube extending through the gastrostomy device and may be configured to seal itself when no feeding tube is disposed through the gastrostomy device. It will be appreciated that other therapeutic devices may also be extended through the gastrostomy device.

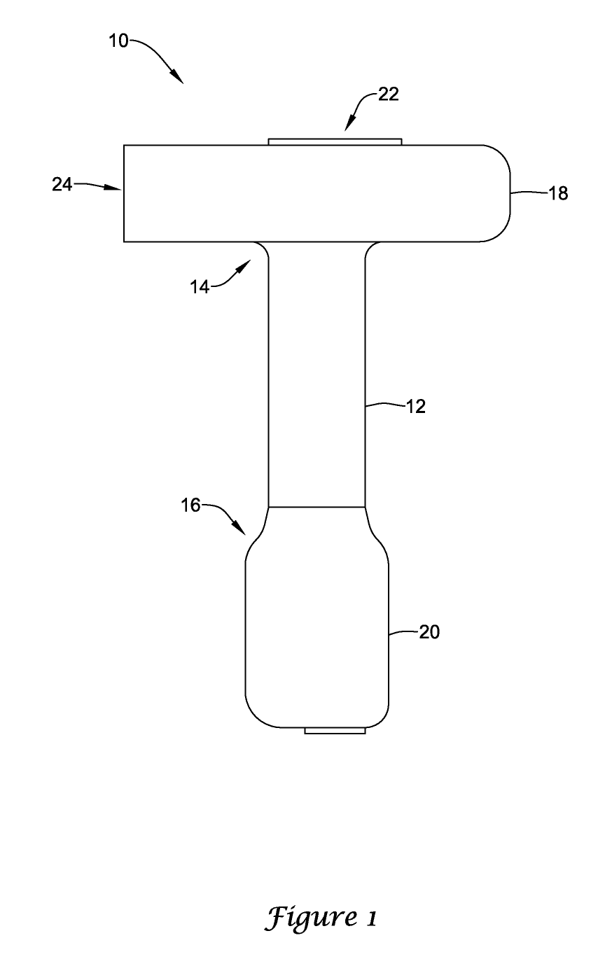

FIG. 1 is a side view of an example gastrostomy device 10. The gastrostomy device 10 includes an elongate tube 12 extending from a proximal end 14 to a distal end 16. A head 18, which may include one or more ports as will be discussed with respect to subsequent Figures, may be secured to the proximal end 14 of the elongate tube 12. A silicone balloon 20 may be secured to the distal end 16 of the elongate tube 12. In some embodiments, for example, the head 18 may include an access port 22 that is configured to accommodate a feeding tube or other therapeutic device. In some embodiments, the head 18 may include an inflation port 24 that enables inflation and/or deflation of the silicone balloon 20.

It will be appreciated that the silicone balloon 20 may be deflated for insertion and may then be expanded to serve as an anchor securing the gastrostomy device 10 relative to the patient's stomach. When the silicone balloon 20 is in its deflated configuration, as shown in FIG. 1, the silicone balloon 20 may be configured to have a relatively small profile such that an outer diameter of the silicone balloon 20 is not more than about ten percent greater than a diameter of the elongate tube 12. In some embodiments, the silicone balloon 20 may have a deflated outer diameter that is nearly flush with the elongate tube 12.

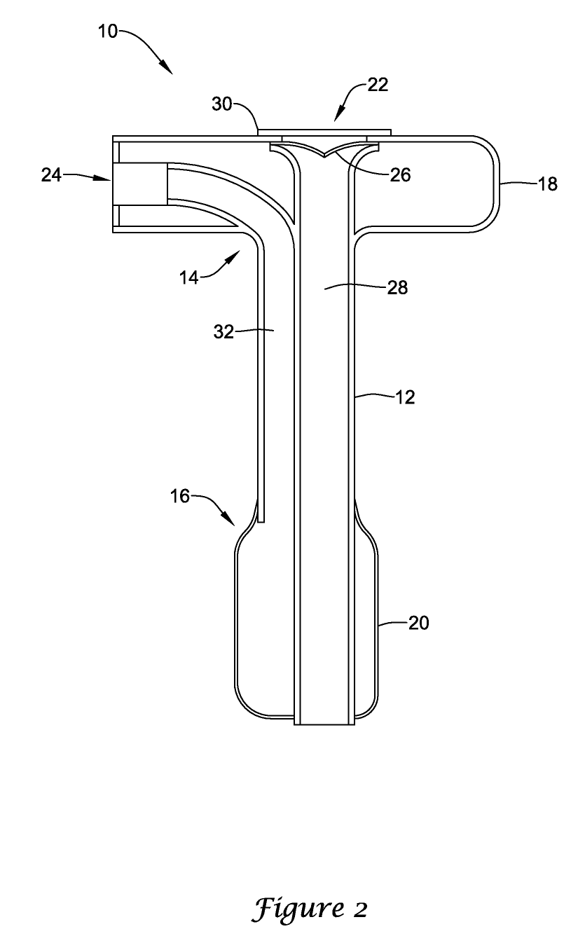

FIG. 2 is a cross-sectional view of the gastrostomy device 10. As can be seen, the access port 22 includes a one-way valve 26 that leads to a channel 28. The channel 28 extends through the elongate tube 12 and through the silicone balloon 20 such that feeding tubes and other therapeutic devices may be deployed through the gastrostomy device 10 and into the interior of the patient's stomach. In some embodiments, the access port 22 may also include a cap 30 that may be secured relative to the access port 22 when the access port 22 is not being used. The cap 30, if present, may help to seal the access port 22 and may help to keep foreign material out of the access port 22.

In some embodiments, the inflation port 24 is in fluid communication with an inflation lumen 32 that extends through the elongate tube 12 and is in fluid communication with the silicone balloon 20. Accordingly, the inflation port 24 may be used to inflate and to deflate the silicone balloon 20. The inflation port 24 is shown schematically, and can be any known inflation valve. It should be noted that while the head 18 is illustrated as a monolithic structure, with the channel 28 and the inflation lumen 32 extending through the head 18 and into the elongate tube 12, in some embodiments the channel 28 and the inflation lumen 32 may be separate tubes extending proximally from the elongate tube 12.

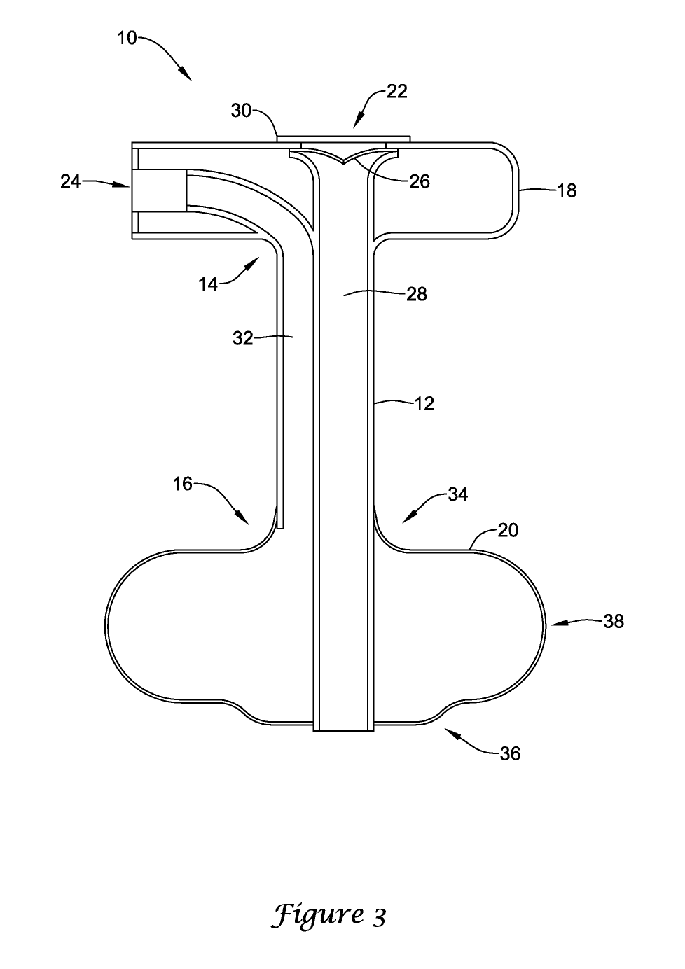

FIG. 3 is similar to FIG. 2 but shows the silicone balloon 20 in an inflated configuration. As can be seen, the silicone balloon 20, particularly when inflated, may be considered as including a proximal region 34, a distal region 36 and an intervening middle region 38. The middle region 38 is configured such that when the silicone balloon 20 is inflated, the middle region 38 stretches or expands more than the proximal region 34 or the distal region 36. For example, the middle region 38 may stretch at least about 25 percent more, when inflated, than the proximal region 34 or the distal region 36. In some embodiments, the silicone balloon 20 is free of any external structure that would otherwise limit or encourage expansion of the silicone balloon 20. Examples of such external structures might include bands disposed over portions of the silicone balloon to limit expansion.

It will be appreciated that providing the silicone balloon 20 with an inflated configuration in which the middle region 38 stretches or expands more than the proximal region 34 or the distal region 36 can provide advantages in helping to secure the gastrostomy device 10 in place. In comparison, an inflatable balloon having a spherical inflated configuration may be easier to pull out, because silicone balloons tend to be fairly deformable. By having a width that is greater than or even substantially greater than a length of the balloon, the silicone balloon 20 is able to better resist forces that could otherwise pull the gastrostomy device 10 out of position.

In some embodiments, for example, the middle region 38 of the silicone balloon 20 may have an inflated diameter that is at least about two times an inflated diameter of the proximal region 34 or the distal region 36. In some embodiments, the middle region 38 of the silicone balloon 20 may have an inflated diameter that is at least about four or five times the diameter of the elongate tube 12. In some embodiments, the middle region 38 of the silicone balloon 20 may have an inflated diameter that is at least about twenty five percent larger than an inflated length of the silicone balloon 20.

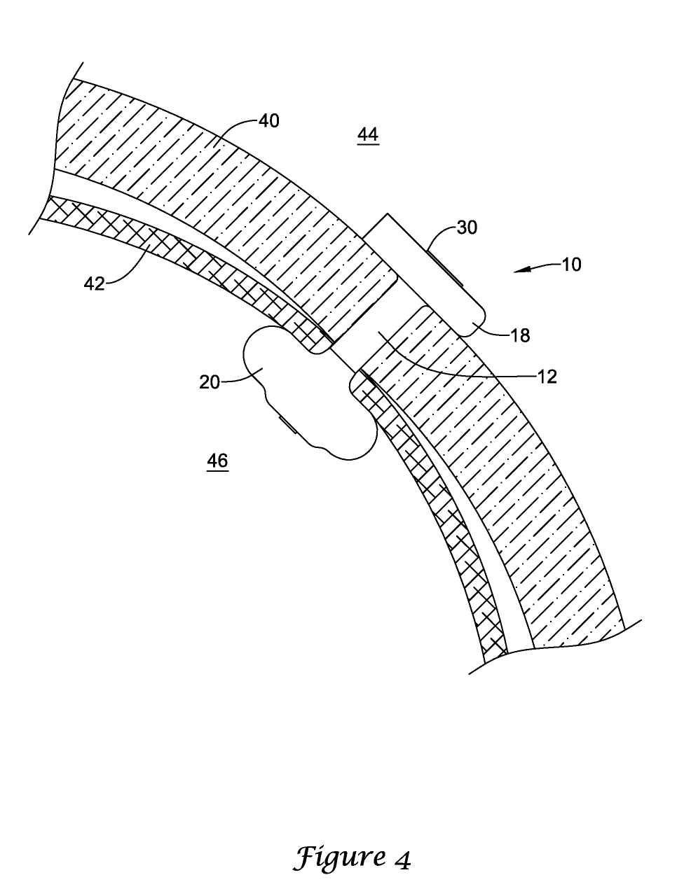

FIG. 4 schematically illustrates the gastrostomy device 10 in use. As shown, the gastrostomy device 10 extends through a tissue layer 40 including the patient's skin and any underlying fat and muscle and into the patient's stomach 42. As shown, the stomach 42 has been pulled into close proximity to the tissue layer 40. This may be accomplished using any known method or technique. It can be seen that the gastrostomy device 10 extends from a position that is outside 44 the patient to a position that is within an interior 46 of the patient's stomach. The silicone balloon 20 is shown in its inflated configuration in which the silicone balloon 20 functions as a button, securing the gastrostomy device 10 in position.

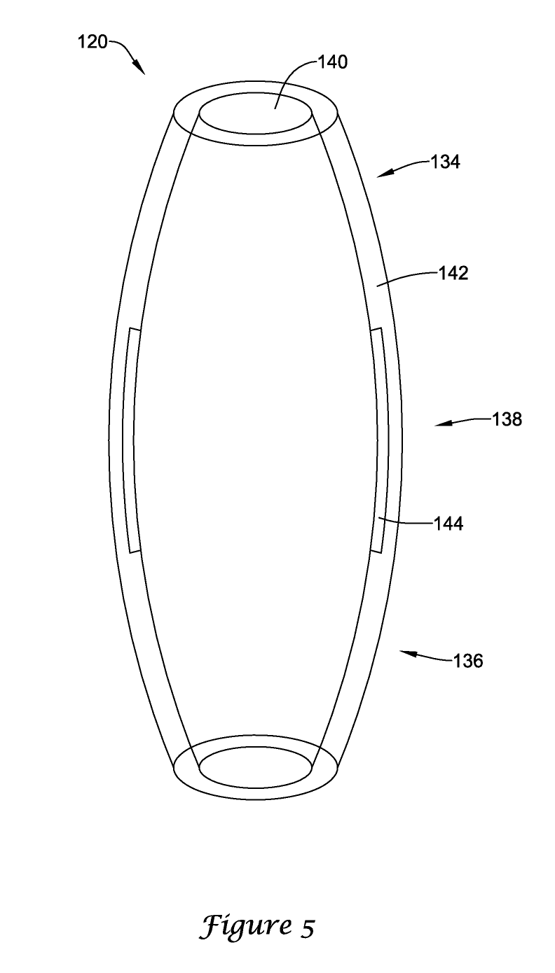

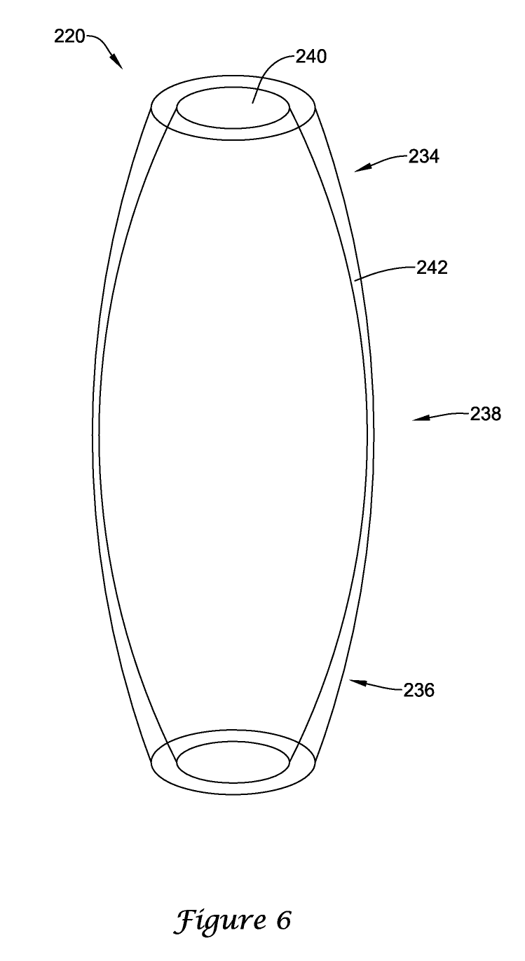

FIGS. 5 and 6 illustrate embodiments of the silicone balloon 20, with differing techniques for providing the silicone balloon 20 with a desired inflated configuration. FIG. 5 illustrates a silicone balloon 120, suitable as use as the silicone balloon 20 in the gastrostomy device 10, in which silicone materials of varying modulus are used to provide preferential stretching while FIG. 6 illustrates a silicone balloon 220, also suitable for use as the silicone balloon 20 in the gastrostomy device 10, in which the relative thickness of the balloon walls are varied in order to provide preferential stretching.

FIG. 5 illustrates a silicone balloon 120 having a proximal region 134, a distal region 136 and an intervening middle region 138. A central lumen 140 extends through the silicone balloon 120 and permits securement of the silicone balloon 120 to the elongate tube 12 (FIG. 1). It will be appreciated that the silicone balloon 120 may be secured to the elongate tube 12 using an adhesive or any other suitable attachment method or technique. The silicone balloon 120 includes a balloon wall 142. In some embodiments, as illustrated, the balloon wall 142 may include a section 144 that is formed of a silicone material having a lower modulus than that of the silicone forming the rest of the balloon wall 142. As a result, the middle region 138 will stretch more, given a particular inflation pressure, than will the proximal region 134 or the distal region 136. As illustrated, the section 144 is shown along an interior of the balloon wall 142. In alternate embodiments, the section 144 may instead be disposed along an exterior of the balloon wall 142. In some embodiments, the bulk of the balloon wall 142, apart from the section 144, may be formed of a silicone having a modulus in the range of about 2 to 10 megaPascal (MPa), or about 3 to 9 Mpa or about 4 to 8 Mpa. In some embodiments, the section 144 may be formed of a silicone having a modulus in the range of less than about 2 Mpa, or less than about 1 Mpa.

FIG. 6 illustrates a silicone balloon 220 having a proximal region 234, a distal region 236 and an intervening middle region 238. A central lumen 240 extends through the silicone balloon 220 and permits securement of the silicone balloon 220 to the elongate tube 12 (FIG. 1). It will be appreciated that the silicone balloon 220 may be secured to the elongate tube 12 using an adhesive or any other suitable attachment method or technique. The silicone balloon 220 includes a balloon wall 242.

In some embodiments, as illustrated, the balloon wall 242 may have a wall thickness that varies. As illustrated, the balloon wall 242 has a wall thickness having a maximum within the proximal region 234 and the distal region 236 and a minimum within the middle region 238. In some embodiments, the wall thickness may vary gradually or in a step-wise fashion. In some embodiments, the balloon wall 242 may vary from a maximum thickness of about 500 microns to a minimum thickness of about 50 microns, or from a maximum thickness of about 400 microns to a minimum thickness of about 100 microns. In some embodiments, the middle region 238 of the balloon wall 242 balloon wall 242 may have a thickness that is reduced to about 25 to about 75 percent relative to the proximal region 234 or the distal region 236. As a result, the middle region 238 will stretch more, given a particular inflation pressure, than will the proximal region 234 or the distal region 236.

FIG. 5 shows the silicone balloon 120 as being formed of several different silicone materials but with a generally constant wall thickness of the balloon wall 142. In some embodiments, the balloon wall 142 may have a non-uniform wall thickness (not shown). FIG. 6 shows the silicone balloon 220 being formed of a single silicone material and with a varying wall thickness of the balloon wall 242. It will be appreciated that in some embodiments, these techniques may be combined. For example, a silicone balloon suitable for use as the silicone balloon 20 (FIG. 1) may be formed of several different silicone materials as well as having a varying wall thickness. The silicone balloons 20, 120, 220 may be formed using any appropriate manufacturing method, including but not limited to spray coating, needle dispensing or injection molding.

The gastrostomy device 10, including the elongate tube 12 and the head 18, may be formed of any suitable polymeric material. Some examples of suitable polymers may include polytetrafluoroethylene (PTFE), ethylene tetrafluoroethylene (ETFE), fluorinated ethylene propylene (FEP), polyoxymethylene (POM, for example, DELRIN® available from DuPont), polyether block ester, polyurethane (for example, Polyurethane 85A), polypropylene (PP), polyvinylchloride (PVC), polyether-ester (for example, ARNITEL® available from DSM Engineering Plastics), ether or ester based copolymers (for example, butylene/poly(alkylene ether) phthalate and/or other polyester elastomers such as HYTREL® available from DuPont), polyamide (for example, DURETHAN® available from Bayer or CRISTAMID® available from Elf Atochem), elastomeric polyamides, block polyamide/ethers, polyether block amide (PEBA, for example available under the trade name PEBAX®), ethylene vinyl acetate copolymers (EVA), silicones, polyethylene (PE), Marlex high-density polyethylene, Marlex low-density polyethylene, linear low density polyethylene (for example REXELL®), polyester, polybutylene terephthalate (PBT), polyethylene terephthalate (PET), polytrimethylene terephthalate, polyethylene naphthalate (PEN), polyetheretherketone (PEEK), polyimide (PI), polyetherimide (PEI), polyphenylene sulfide (PPS), polyphenylene oxide (PPO), poly paraphenylene terephthalamide (for example, KEVLAR®), polysulfone, nylon, nylon-12 (such as GRILAMID® available from EMS American Grilon), perfluoro(propyl vinyl ether) (PFA), ethylene vinyl alcohol, polyolefin, polystyrene, epoxy, polyvinylidene chloride (PVdC), poly(styrene-b-isobutylene-b-styrene) (for example, SIBS and/or SIBS 50A), polycarbonates, ionomers, biocompatible polymers, other suitable materials, or mixtures, combinations, copolymers thereof, polymer/metal composites, and the like.

In some embodiments, the exterior surface of the gastrostomy device 10 may include a lubricious coating, a hydrophilic coating, a protective coating, or other type of coating. Hydrophobic coatings such as fluoropolymers provide a dry lubricity which improves handling. Lubricious coatings improve insertion capability. Suitable lubricious polymers are well known in the art and may include silicone and the like, hydrophilic polymers such as high-density polyethylene (HDPE), polytetrafluoroethylene (PTFE), polyarylene oxides, polyvinylpyrrolidones, polyvinylalcohols, ligns 1 alkyl cellulosics, ligns, saccharides, caprolactones, and the like, and mixtures and combinations thereof. Hydrophilic polymers may be blended among themselves or with formulated amounts of water insoluble compounds (including some polymers) to yield coatings with suitable lubricity, bonding, and solubility. Some other examples of such coatings and materials and methods used to create such coatings can be found in U.S. Pat. Nos. 6,139,510 and 5,772,609, which are incorporated herein by reference.

### Embodiments

1. A gastrostomy device includes an elongate tube extending from a proximal end to a distal end and having a tube diameter. An inflation lumen extends along the elongate tube and an inflation port is disposed near the proximal end of the elongate tube and is in fluid communication with the inflation lumen. A silicone balloon is secured relative to the distal end of the elongate tube and is in fluid communication with the inflation lumen, the silicone balloon having a distal region, a proximal region and an intervening middle region that, when inflated, stretches at least 25 percent further than the distal region of the silicone balloon or the proximal region of the silicone balloon.

2. The gastrostomy device of example 1 in which the elongate tube has a length that enables the elongate tube to extend from a position exterior a patient to a position interior the patient's stomach.

3. The gastrostomy device of example 1 in which the silicone balloon has an inflated configuration in which the silicone balloon holds the distal end of the elongate tube secured within the patient's stomach.

4. The gastrostomy device of examples 1 to 3, further including a resealable valve disposed within the proximal end of the elongate tube.

5. The gastrostomy device of any of examples 1 to 4 in which the silicone balloon has a low profile deflated configuration in which the silicone balloon has an outer diameter that is no more than about ten percent greater than the tube diameter in order to facilitate insertion.

6. The gastrostomy device of any of examples 1 to 5 in which the silicone balloon has an inflated configuration in which the silicone balloon holds the distal end of the elongate tube secured within the patient's stomach.

7. The gastrostomy device of any of examples 1 to 6 in which the intervening middle region of the silicone balloon has an inflated diameter that is at least about two times an inflated diameter of the distal region of the silicone balloon or the proximal region of the silicone balloon.

8. The gastrostomy device of any of examples 1 to 7 in which the intervening middle region of the silicone balloon has an inflated diameter that is at least about four times the tube diameter.

9. The gastrostomy device of any of examples 1 to 8 in which the intervening middle region of the silicone balloon has an inflated diameter that is at least about five times the tube diameter.

10. The gastrostomy device of any of examples 1 to 9 in which the intervening middle region has a reduced wall thickness relative to a distal region wall thickness or a proximal region wall thickness.

11. The gastrostomy device of example 10 in which the wall thickness of the intervening middle region is reduced about 25 to about 75 percent relative to the distal wall thickness or the proximal wall thickness.

12. The gastrostomy device of any of examples 1 to 11 in which the intervening middle region includes silicone having a lower modulus relative to silicone in a distal region of the silicone balloon or a proximal region of the silicone balloon.

13. The gastrostomy device of example 12 in which the silicone balloon has a non-uniform wall thickness.

14. The gastrostomy device of example 12 in which the silicone balloon has an inner surface and an outer surface, and the lower modulus silicone is disposed in the intervening middle region proximate the inner surface of the silicone balloon and a higher modulus silicone is disposed in the intervening middle region proximate the outer surface of the silicone balloon.

15. The gastrostomy device of any of examples 1 to 14 in which the intervening middle region of the silicone balloon has an inflated diameter that is at least about 25 percent larger than an inflated length of the balloon.

16. A gastrostomy device includes an elongate tube extending from a proximal end to a distal end and having a tube diameter, the elongate tube having a length that enables the elongate tube to extend from a position exterior a patient to a position interior the patient's stomach. A resealable valve is disposed within the proximal end of the elongate tube. An inflation lumen extends along the elongate tube and an inflation port is disposed near the proximal end of the elongate tube and is in fluid communication with the inflation lumen. A silicone balloon is secured relative to the distal end of the elongate tube and is in fluid communication with the inflation lumen. The silicone balloon has a distal region, a proximal region and an intervening middle region that, when inflated, stretches more than the distal region or the proximal region.

17. The gastrostomy device of example 16 in which the silicone balloon has a low profile deflated configuration in which the silicone balloon has an outer diameter within about ten percent of the tube diameter in order to facilitate insertion.

18. The gastrostomy device of examples 16 or 17 in which the silicone balloon has an inflated configuration in which the silicone balloon holds the distal end of the elongate tube secured within the patient's stomach.

19. The gastrostomy device of examples 16 to 18 in which the middle region of the silicone balloon has an inflated diameter that is at least about two times an inflated diameter of the distal region or the proximal region.

20. The gastrostomy device of examples 16 to 19 in which the middle region of the silicone balloon has an inflated diameter that is at least about four or five times the tube diameter.

21. The gastrostomy device of examples 16 to 20 in which the middle region has a reduced wall thickness relative to a distal region wall thickness or a proximal region wall thickness.

22. The gastrostomy device of examples 16 to 21 in which the middle region includes silicone having a lower modulus relative to silicone in a distal region or a proximal region.

23. A gastrostomy device includes an elongate tube extending from a proximal end to a distal end, an inflation lumen extending along the elongate tube and a silicone balloon secured relative to the distal end of the elongate tube and in fluid communication with the inflation lumen, the silicone balloon having a distal region, a proximal region and an intervening middle region. The middle region has a reduced wall thickness relative to a distal region wall thickness or a proximal region wall thickness such that when inflated the middle region of the silicone balloon will preferentially expand more than the distal region or the proximal region.

24. The gastrostomy device of example 23, further including a resealable valve disposed within the proximal end of the elongate tube.

25. The gastrostomy device of examples 23 or 24, further including an inflation port disposed near the proximal end of the elongate tube and in fluid communication with the inflation lumen.

26. The gastrostomy device of examples 23 to 25 in which the middle region of the silicone balloon has an inflated diameter that is at least about twice an inflated diameter of the distal region or the proximal region.

27. The gastrostomy device of examples 23 to 26 in which the middle region of the silicone balloon has an inflated diameter that is at least about 25 percent larger than an inflated length of the balloon.

28. The gastrostomy device of examples 23 to 27 in which the wall thickness of the middle region is reduced about 25 to about 75 percent relative to the distal wall thickness or the proximal wall thickness.

29. The gastrostomy device of examples 23 to 28 in which the silicone balloon is free of any external structure limiting or encouraging expansion of the silicone balloon.

30. A gastrostomy device includes an elongate tube extending from a proximal end to a distal end, an inflation lumen extending along the elongate tube, and a silicone balloon secured relative to the distal end of the elongate tube and in fluid communication with the inflation lumen, the silicone balloon having a distal region, a proximal region and an intervening middle region. The middle region includes a lower modulus silicone relative to silicone in a distal region or a proximal region such that when inflated the middle region of the silicone balloon will preferentially expand more than the distal region or the proximal region.

31. The gastrostomy device of example 30, further including a resealable valve disposed within the proximal end of the elongate tube.

32. The gastrostomy device of examples 30 or 31, further including an inflation port disposed near the proximal end of the elongate tube and in fluid communication with the inflation lumen.

33. The gastrostomy device of examples 30 to 32 in which the balloon has an inner surface and an outer surface, and the lower modulus silicone is disposed in the middle region proximate the inner surface and a higher modulus silicone is disposed in the middle region proximate the outer surface.

34. The gastrostomy device of examples 30 to 33 in which the middle region of the balloon has an inflated diameter that is at least about twice an inflated diameter of the distal region or the proximal region.

35. The gastrostomy device of examples 30 to 34 in which the middle region of the balloon has an inflated diameter that is at least about 25 percent larger than an inflated length of the balloon.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A gastrostomy device comprising:
an elongate tube extending from a proximal end to a distal end and having a tube diameter, the elongate tube having a length that enables the elongate tube to extend from a position exterior a patient to a position interior the patient's stomach;
a resealable valve disposed within the proximal end of the elongate tube;
an inflation lumen extending along the elongate tube;
an inflation port disposed near the proximal end of the elongate tube and in fluid communication with the inflation lumen; and
a silicone balloon secured relative to the distal end of the elongate tube and in fluid communication with the inflation lumen, the silicone balloon having a distal region, a proximal region and an intervening middle region that, when inflated, stretches more than the distal region of the silicone balloon or the proximal region of the silicone balloon.

2. The gastrostomy device of claim 1, wherein the silicone balloon has a low profile deflated configuration in which the silicone balloon has an outer diameter within about ten percent of the tube diameter in order to facilitate insertion.

3. The gastrostomy device of claim 2, wherein the silicone balloon has an inflated configuration in which the silicone balloon holds the distal end of the elongate tube secured within the patient's stomach.

4. The gastrostomy device of claim 1, wherein the intervening middle region of the silicone balloon has an inflated diameter that is at least about two times an inflated diameter of the distal region of the silicone balloon or the proximal region of the silicone balloon.

5. The gastrostomy device of claim 1, wherein the intervening middle region of the silicone balloon has an inflated diameter that is at least about four times the tube diameter.

6. The gastrostomy device of claim 1, wherein the intervening middle region has a reduced wall thickness relative to a distal region wall thickness or a proximal region wall thickness.

7. The gastrostomy device of claim 1, wherein the intervening middle region includes silicone having a lower modulus relative to silicone in a distal region of the silicone balloon or a proximal region of the silicone balloon.

8. A gastrostomy device comprising:
an elongate tube extending from a proximal end to a distal end;
an inflation lumen extending along the elongate tube; and
a silicone balloon secured relative to the distal end of the elongate tube and in fluid communication with the inflation lumen, the silicone balloon having a distal region, a proximal region and an intervening middle region;
wherein the intervening middle region has a reduced wall thickness relative to a distal region wall thickness or a proximal region wall thickness such that when inflated the intervening middle region of the silicone balloon will preferentially expand more than the distal region or the proximal region.

9. The gastrostomy device of claim 8, further comprising a resealable valve disposed within the proximal end of the elongate tube.

10. The gastrostomy device of claim 8, further comprising an inflation port disposed near the proximal end of the elongate tube and in fluid communication with the inflation lumen.

11. The gastrostomy device of claim 8, wherein the intervening middle region of the silicone balloon has an inflated diameter that is at least about twice an inflated diameter of the distal region of the silicone balloon or the proximal region of the silicone balloon.

12. The gastrostomy device of claim 8, wherein the middle region of the silicone balloon has an inflated diameter that is at least about 25 percent larger than an inflated length of the silicone balloon.

13. The gastrostomy device of claim 8, wherein the wall thickness of the intervening middle region is reduced about 25 to about 75 percent relative to the distal wall thickness or the proximal wall thickness.

14. The gastrostomy device of claim 8, wherein the silicone balloon is free of any external structure limiting or encouraging expansion of the silicone balloon.

15. A gastrostomy device comprising:
an elongate tube extending from a proximal end to a distal end;
an inflation lumen extending along the elongate tube; and
a silicone balloon secured relative to the distal end of the elongate tube and in fluid communication with the inflation lumen, the silicone balloon having a distal region, a proximal region and an intervening middle region;
wherein the intervening middle region includes a lower modulus silicone relative to silicone in a distal region of the silicone balloon or a proximal region of the silicone balloon such that when inflated the intervening middle region of the silicone balloon will preferentially expand more than the distal region of the silicone balloon or the proximal region of the silicone balloon.

16. The gastrostomy device of claim 15, further comprising a resealable valve disposed within the proximal end of the elongate tube.

17. The gastrostomy device of claim 15, further comprising an inflation port disposed near the proximal end of the elongate tube and in fluid communication with the inflation lumen.

18. The gastrostomy device of claim 15, wherein the silicone balloon has an inner surface and an outer surface, and the lower modulus silicone is disposed in the intervening middle region proximate the inner surface and a higher modulus silicone is disposed in the intervening middle region proximate the outer surface.

19. The gastrostomy device of claim 15, wherein the intervening middle region of the silicone balloon has an inflated diameter that is at least about twice an inflated diameter of the distal region of the silicone balloon or the proximal region of the silicone balloon.

20. The gastrostomy device of claim 15, wherein the intervening middle region of the silicone balloon has an inflated diameter that is at least about 25 percent larger than an inflated length of the silicone balloon.
